(19) United States
(12) Patent Application Publication
(10) Pub. No.: US 2009/0295702 A1
(43) Pub. Date: Dec. 3, 2009

(54) LCD DRIVE METHOD

(75) Inventors: Tzu-Yun HSU, Taichung County (TW); Chi-Hung Lin, Taichung County (TW)

Correspondence Address: Muncy, Geissler, Olds & Lowe, PLLC, P.O. BOX 1364, FAIRFAX, VA, 22038-1364, US

(73) Assignee: UNITED RADIANT TECHNOLOGY CORP.

(21) Appl. No.: 12/127,291

(22) Filed: May 27, 2008

(51) Int. Cl. G09G 3/36

(52) U.S. Cl. 345/94

(57) ABSTRACT

The present invention discloses an LCD drive method, which uses a signal of at least one segment electrode of a multiplex drive element as a common-electrode signal and uses the voltage difference of the above-mentioned segment electrode and the signal of another segment electrode to present images, whereby the multiplex drive element can function as a static drive element. Via the present invention, the multiplex drive element, which can be mass-produced in low costs, can replace the high-cost customized static drive element. Therefore, the present invention can be used as a solution for the static drive LCD and reduce the costs thereof.

### FIELD OF THE INVENTION

The present invention relates to an LCD drive method, particularly to a static LCD drive method.

### BACKGROUND OF THE INVENTION

The LCD (Liquid Crystal Display) drive methods are categorized into the active type and the passive type. The passive drive method is further divided into the static drive method and the multiplex drive method. Refer to FIG. 1, FIGS. 2A-2C, and FIGS. 3A-3B for the structure, voltage waveforms and voltage difference waveforms of a conventional static drive LCD, wherein liquid crystal in a dot 1 is driven by the voltage difference of a segment electrode 2 and a common electrode 3. The voltage difference creates the common-segment OFF and the common-segment ON driving voltage waveforms (shown in FIGS. 3A-3B) to control the transparent and opaque states of liquid crystal in the dot 1. Refer to FIG. 4, FIGS. 5A-5C, and FIGS. 6A-6B for the structure and voltage waveforms of a conventional multiplex drive LCD, wherein a ⅕ duty cycle and a ¼ bias are used in the example, and wherein the voltage differences of the segment electrodes (S1-Sn) and the common electrodes (C1-Cn) create the common-segment OFF and the common-segment ON driving voltage waveforms (shown in FIGS. 6A-6B) to control the transparent and opaque states of liquid crystal in a dot.

The resolution of LCD is persistently growing. Therefore, the multiplex drive LCD which is circuit layout-efficient and can be mass-produced in low costs has become the mainstream. The static drive LCD still has applications in some special fields. However, the static drive LCD needs a customized driver if high resolution is required. Thus, the costs thereof are obviously increased.

### SUMMARY OF THE INVENTION

One objective of the present invention is to provide a method to simulate a static drive element with a multiplex drive element.

To achieve the above-mentioned objective, the present invention proposes an LCD drive method, which simulates the drive method of a static drive element, and which uses a signal of at least one of segment electrodes of a multiplex drive element to simulate the signal of the common electrode of the static drive element and uses a voltage signal of another segment electrode of the multiplex drive element to simulate a voltage signal of a segment electrode of the static drive element.

The present invention uses the signals of a static drive element to simulate the signals of the common electrode and the segment electrode of a static drive element and uses the voltage difference thereof to drive LCD to present images. As the present invention can simulate a static drive element with a multiplex drive element, which can be mass-produced in low costs, the present invention can reduce the costs of LCD.

### BRIEF DESCRIPTION OF THE DRAWINGS

FIG. 1 is a diagram schematically showing the structure of a conventional static drive LCD.

FIGS. 2A-2C are diagrams schematically showing the voltage waveforms of a conventional static drive method.

FIGS. 3A-3B are diagrams schematically showing the voltage difference waveforms of a conventional static drive method.

FIG. 4 is a diagram schematically showing the structure of a conventional multiplex drive LCD.

FIGS. 5A-5C are diagrams schematically showing the voltage waveforms of a conventional multiplex drive method.

FIGS. 6A-6B are diagrams schematically showing the voltage difference waveforms of a conventional multiplex drive method.

FIGS. 7A-7C are diagrams schematically showing the voltage waveforms according to the present invention.

FIGS. 8A-8B are diagrams schematically showing the voltage difference waveforms according to the present invention.

FIGS. 9A-9B are diagrams schematically showing the voltage difference waveforms for creating a gray-level effect according to the present invention.

### DETAILED DESCRIPTION OF THE PREFERRED EMBODIMENTS

Below, the technical contents of the present invention will be described in detail with the embodiments. However, the embodiments are only to exemplify the present invention but not to limit the scope of the present invention.

The present invention is an LCD drive method, which simulates the drive method of a static drive element.

Firstly, a multiplex drive element is provided, and the multiplex drive element has a plurality of segment electrodes outputting voltage signals. Refer to FIGS. 7A-7B for the segment ON and segment OFF waveforms.

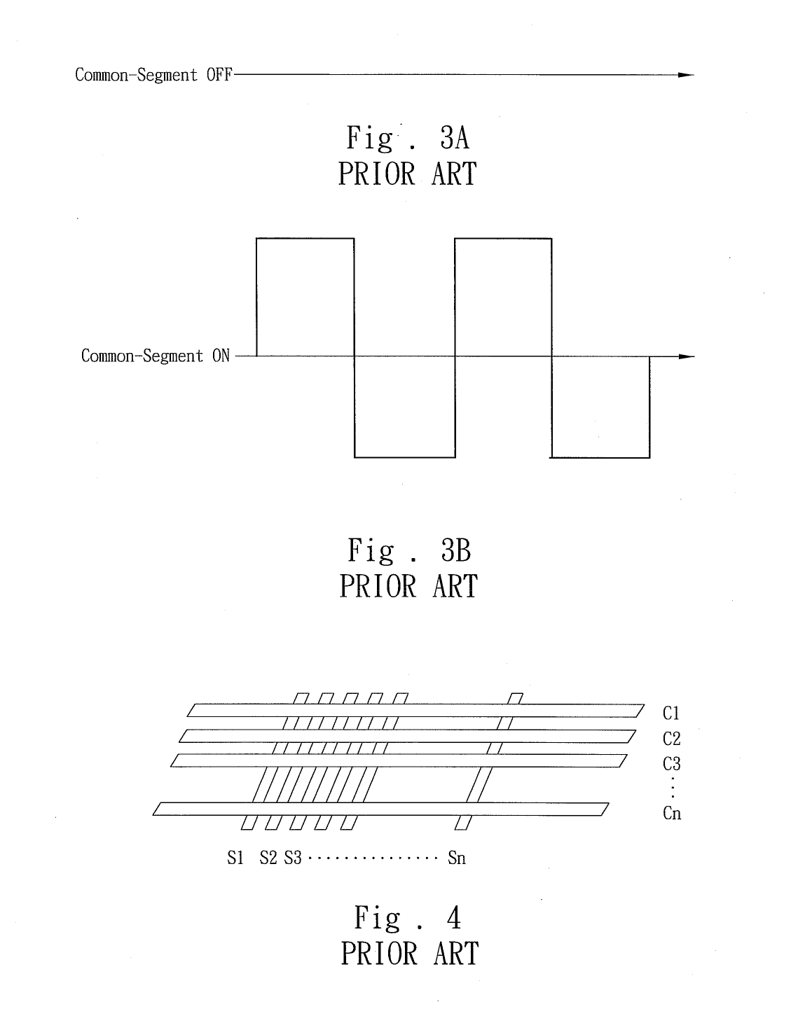

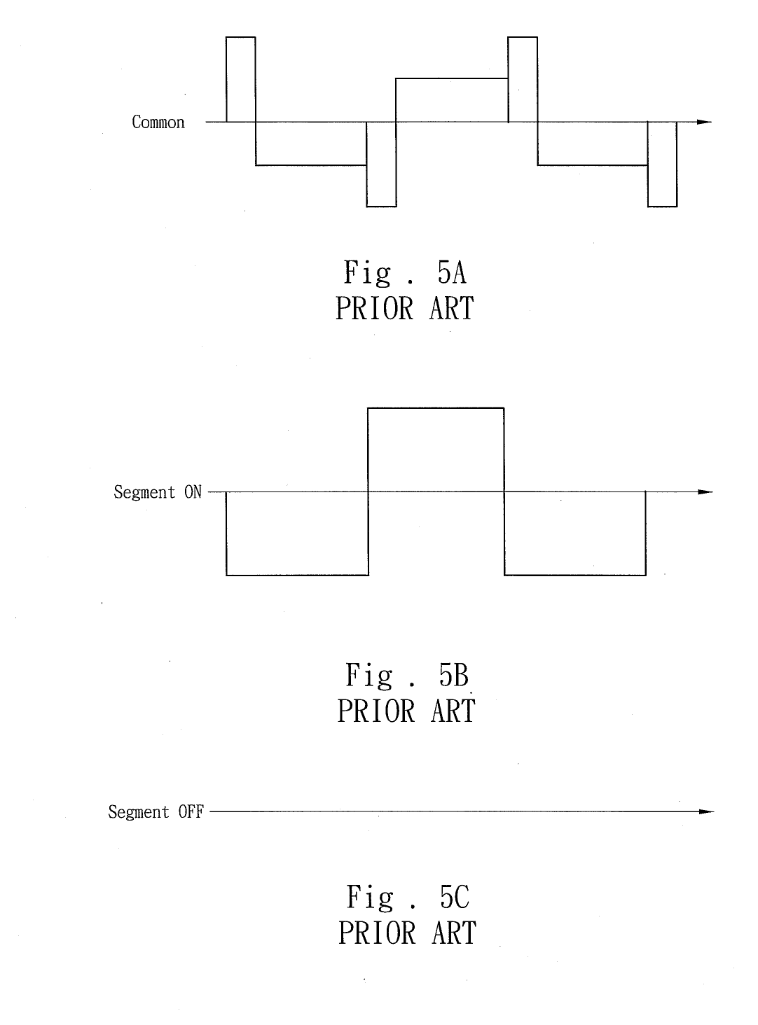

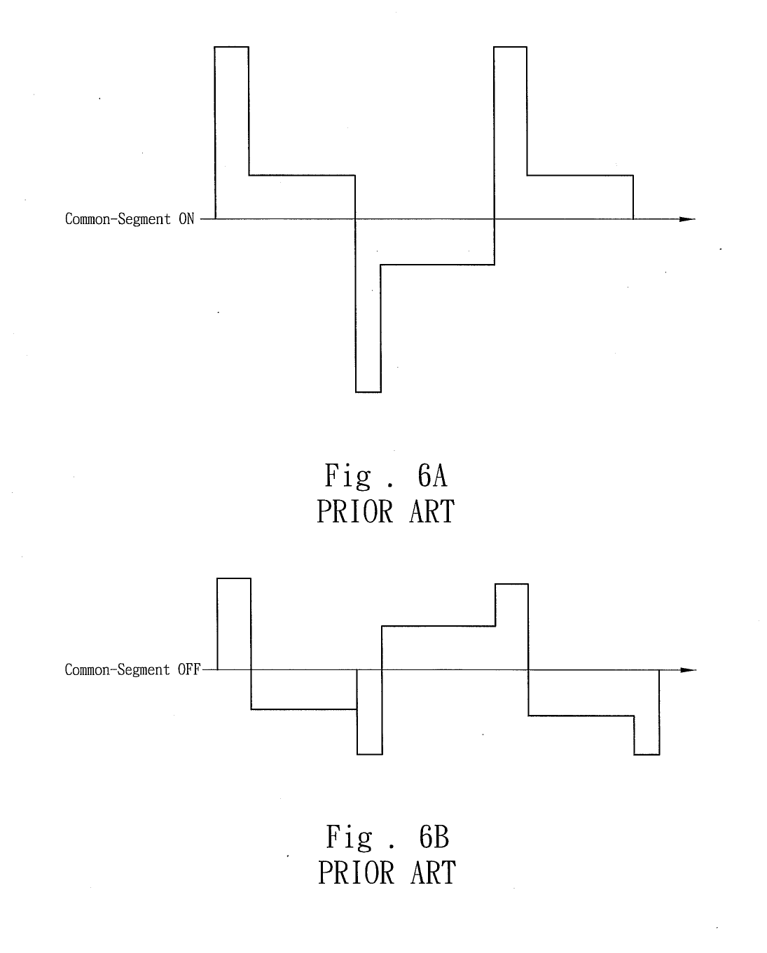

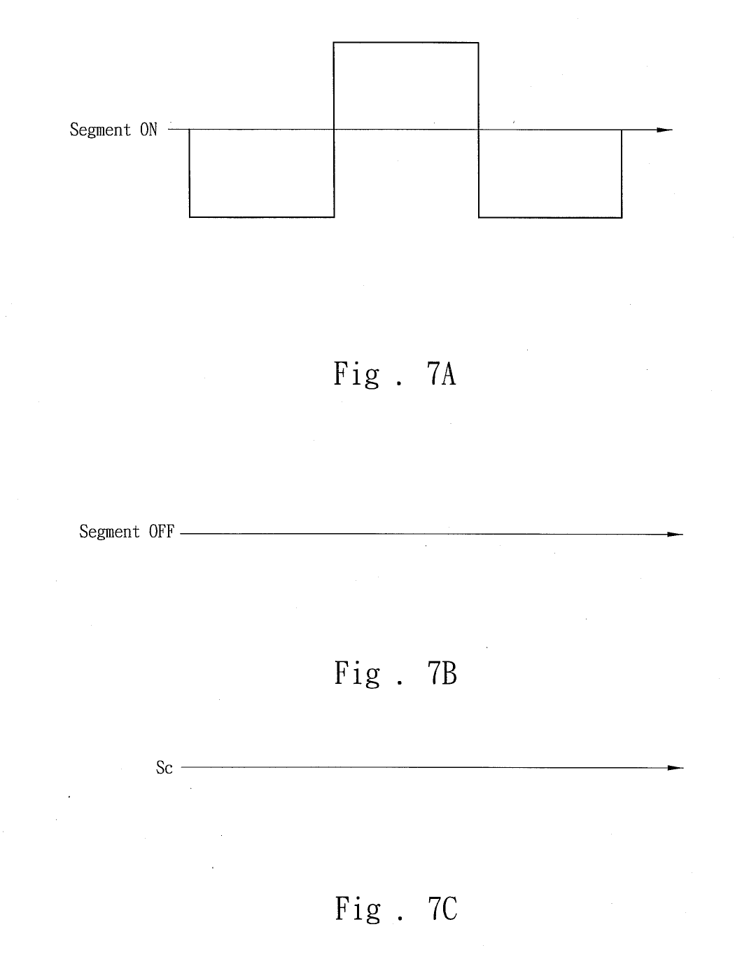

Refer to FIG. 3C. The voltage signal output by one of the segment electrodes is defined to be a first voltage signal Sc. The first voltage signal Sc adopts the segment OFF waveform, and another voltage signal is defined to be a second voltage signal Ss.

Next, the voltage signal, which is output by the segment electrode of the static drive element and defined to be the first voltage signal Sc, simulates the voltage signal of the common electrode of a static drive element, and the voltage signal, which is output by the segment electrode of the static drive element and defined to be the second voltage signal Ss, simulates the voltage signal of the segment electrode of the static drive element.

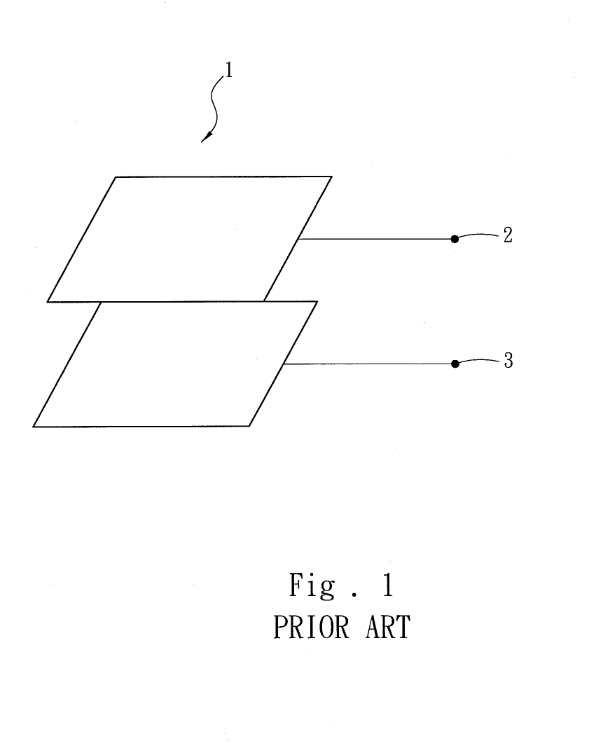

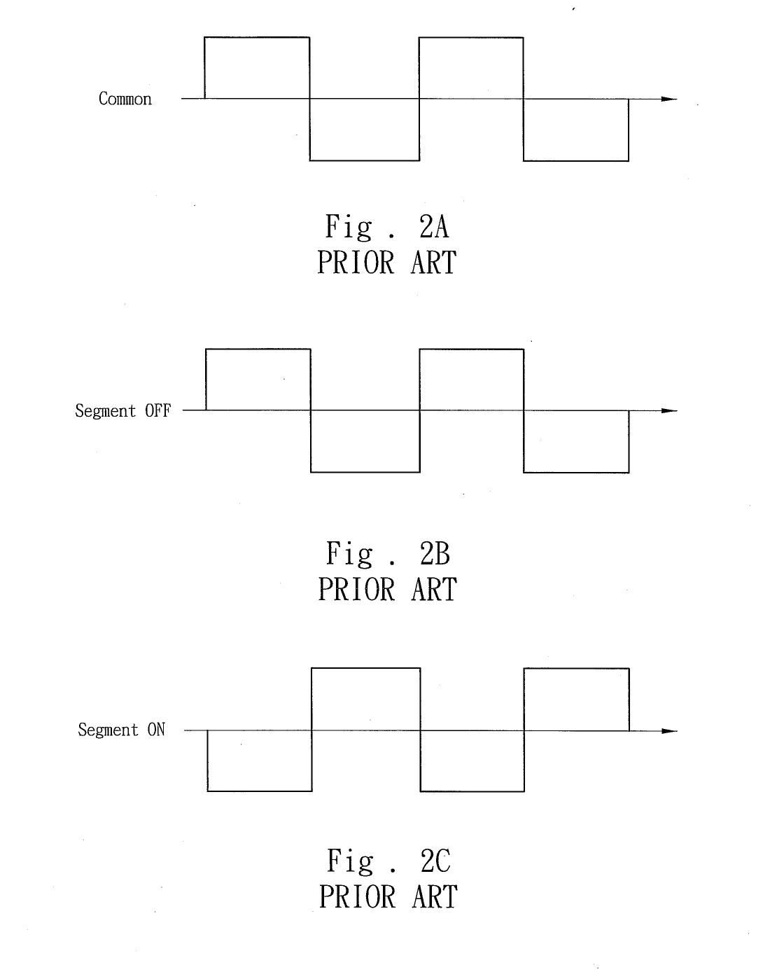

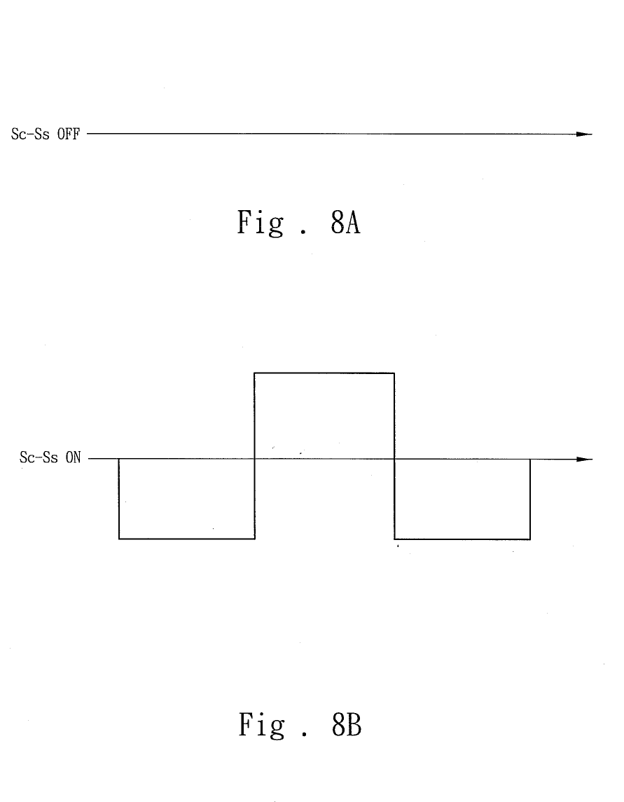

Then, the voltage differences of the first and second voltage signals Sc and Ss, which respectively simulates the common-electrode voltage signal and the segment-electrode voltage signal of the static drive element, are used as the driving signals of the static drive element to present images. Refer to FIGS. 8A-8B for the voltage differences of the first and second voltage signals Sc and Ss (the segment OFF and segment ON voltage signals). The first and second voltage signals Sc and Ss are respectively input to the common electrode 3 and the segment electrode 2 in FIG. 1 to create voltage differences to statically drive a dot 1 in FIG. 1 and present images.

In the simulate static drive element of the present invention, the voltage differences of a portion of the duty cycle of the first and second voltage signals Sc and Ss, which respectively simulate the common-electrode voltage signal and the segment-electrode voltage signal of the static drive element, are used to create the gray-level effect.

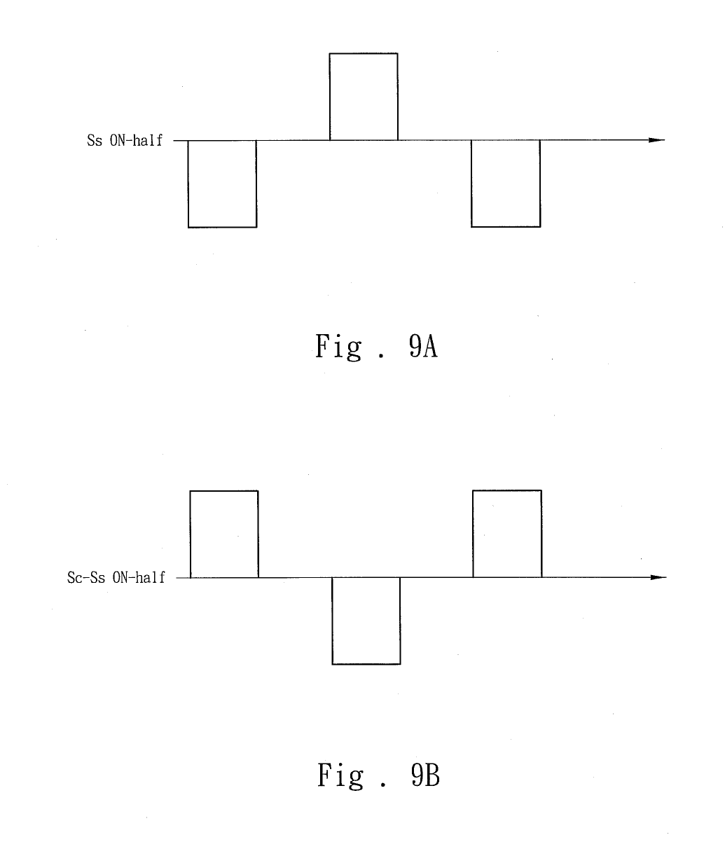

Refer to FIGS. 9A-9B. The simulate static drive element of the present invention selects the waveform in a certain interval to present the gray-level effect, and the interval of half a cycle is used in FIGS. 9A-9B. Besides, the present invention may adopt a plurality of multiplex drive elements, which simulate static drive elements, to work together and satisfy high resolution static drive applications.

In conclusion, the present invention adopts the voltage differences of the first and second voltage signals Sc and Ss to simulate the operations of the static drive element and present images. Therefore, the present invention can use multiplex drive elements, which can be mass-produced in low costs, to simulate and replace static drive elements. Via the present invention, LCD does not necessarily use the high-cost customized static drive elements, and the costs of LCD are reduced.

What is claimed is:

1. A liquid crystal display drive method, which simulates the drive method of a static drive element, comprising steps:
providing a multiplex drive element having a plurality of segment electrodes outputting voltage signals;
defining a voltage signal output by at least one said segment electrode to be a first voltage signal, and defining a voltage signal output by another said segment electrode to be a second voltage signal;
using said first voltage signal, which is output by said segment electrode, to simulate a signal of a common electrode of said static drive element, and using said second voltage signal, which is output by another said segment electrode, to simulate a signal of a segment electrode of said static drive element; and
using voltage differences of said first voltage signal and said second voltage signal to simulate operations of said static drive element and present images.

2. The liquid crystal display drive method according to claim 1, wherein voltage differences of a portion of a duty cycle of said first and second voltage signals, which respectively simulate a common-electrode voltage signal and a segment-electrode voltage signal of said static drive element, are used to create a gray-level effect.

3. The liquid crystal display drive method according to claim 1, wherein said plurality of multiplex drive elements works together.
